(19) United States
(12) Patent Application Publication
(10) Pub. No.: US 2025/0205782 A1
(43) Pub. Date: Jun. 26, 2025

(54) HIGH SURFACE AREA ELECTRODES ENABLED BY LOW-TEMPERATURE WELDING OF COPPER NANOPOROUS POWDERS AND NANOPARTICLES HYBRID FEEDSTOCKS

(71) Applicants: Stanislau Niauzorau, Gilbert, AZ (US); Natalya Kublik, Tempe, AZ (US); Emmanuel Dasinor, Tempe, AZ (US); Amm G. Hasib, Tempe, AZ (US); Aliaksandr Sharstniou, Gilbert, AZ (US); Bruno Azeredo, Scottsdale, AZ (US)

(72) Inventors: Stanislau Niauzorau, Gilbert, AZ (US); Natalya Kublik, Tempe, AZ (US); Emmanuel Dasinor, Tempe, AZ (US); Amm G. Hasib, Tempe, AZ (US); Aliaksandr Sharstniou, Gilbert, AZ (US); Bruno Azeredo, Scottsdale, AZ (US)

(21) Appl. No.: 18/989,898

(22) Filed: Dec. 20, 2024

Related U.S. Application Data
(60) Provisional application No. 63/614,312, filed on Dec. 22, 2023.

(51) Int. Cl. B22F 9/16; B23K 35/30

(52) U.S. Cl. CPC B22F 9/16; B23K 35/302; B22F 2301/10

(57) ABSTRACT

Preparing nanoporous copper powder includes contacting a precursor powder that includes copper and aluminum with NaOH to dealloy the power, thereby yielding nanoporous copper powder; washing the nanoporous copper powder; drying the nanoporous copper powder; and passivating the nanoporous copper powder to form a copper oxide layer on the nanoporous copper powder. Welding nanoporous copper powder includes heating a feedstock that includes the nanoporous copper powder in a reducing atmosphere to reduce the nanoporous copper powder and heating the feedstock at a temperature in a range of 100-500° C. to yield a nanoporous welded solid.

### CROSS-REFERENCE TO RELATED APPLICATION

This application claims the benefit of U.S. Patent Application No. 63/614,312 filed on Dec. 22, 2023, which is incorporated herein by reference in its entirety.

### STATEMENT OF GOVERNMENT SUPPORT

This invention was made with government support under 1932899 awarded by the National Science Foundation. The government has certain rights in the invention.

### TECHNICAL FIELD

This invention relates to low-temperature welding of copper nanoporous powders and nanoparticles.

### BACKGROUND

Nanoporous metal powder (NPMP) has been used as a feedstock for powder for metallurgy processes such as powder casting and additive manufacturing. Methods for kilogram- scale production of NPMP can be limited in material selection or throughput.

### SUMMARY

This disclosure describes solid and electrically conductive copper parts produced by exploiting Ostwald ripening and nanoscale welding between nanoporous metal powder (NPMP) and mixtures of NPMP and Cu nanoparticles at sintering temperatures as low as 28% of the melting temperature of bulk copper. First, the large-scale bulk synthesis (e.g., 0.1 kg/h with a single tabletop 5 L beaker) of nanoporous copper powder (PCu) is investigated by (i) titrating NaOH into a suspension of copper-aluminum (CuAl) powder and water and (ii) by titrating CuAl powder into a NaOH solution. The latter approach is found to avoid the formation of bayerite precipitates and copper oxides (e.g., Cu₂O and CuO) by maintaining high concentrations of NaOH (e.g., 3 M) during dealloying. Second, its surface passivation with a copper oxide layer by exposing it to ambient conditions and its effect on thermal coarsening of PCu are observed as a function of powder quantity in the beaker with a constant aspect ratio. Third, the hybrid feedstock containing 8.8 to 34.5 vol % of 300 nm Cu nanoparticles (CuNPs) and PCu powder was fabricated in order to increase the packing density and facilitate nanoscale welding via Ostwald ripening of nanoparticles which promotes necking of the micron-sized PCu powders. Fourth, the hybrid feedstock is subjected to sintering in an open-die graphite mold in reducing atmosphere at a temperature range of 300-700° C. to fabricate electrically conductive parts. Finally, parts were submitted to compression testing achieved a low mechanical strength (e.g., maximum ultimate compression strength of 17.8 MPa) with preserved porosity and ligament sizes ranging between 24-36 nm which is attributed to the high thermal stability of PCu ligaments between 300-600° C.

In a first general aspect, preparing nanoporous copper powder includes contacting a precursor powder that includes copper and aluminum with NaOH to dealloy the power thereby yielding nanoporous copper powder, washing the nanoporous copper powder, drying the nanoporous copper powder, and passivating the nanoporous copper powder to form a copper oxide layer on the nanoporous copper powder.

Implementations of the first general aspect may include one or more of the following features. In some cases, contacting the precursor powder with the NaOH includes adding the NaOH to an aqueous mixture including the powder. In some cases, contacting the precursor powder with NaOH includes adding the precursor powder to an aqueous solution of NaOH. The precursor powder may include spherical copper-aluminum particles.

The nanoporous copper powder can be substantially free of copper oxides before passivating the nanoporous copper powder. Passivating the nanoporous copper powder includes maintaining the nanoporous copper powder at a temperature below about 200° C. After passivating, the nanoporous copper powder can be free of CuO.

The method may further include combining the nanoporous copper powder with copper nanoparticles to yield a powder mixture. The powder mixture may include up to 40 vol % of the copper nanoparticles. The particle size of the precursor powder can be in a range of about 10 nm to about 30 μm.

In a second general aspect, welding nanoporous copper powder includes heating a feedstock that includes the nanoporous copper powder in a reducing atmosphere to reduce the nanoporous copper powder and heating the feedstock at a temperature in a range of 100-500° C. to yield a nanoporous welded solid.

Implementations of the second general aspect may include one or more of the following features. The reducing atmosphere can include H₂. The feedstock may further include copper nanoparticles. In some cases, the feedstock can include up to 40 vol % of the copper nanoparticles. The method may further include casting the feedstock in a mold before heating the feedstock. The method may further include removing the nanoporous welded solid from the mold.

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF DRAWINGS

FIG. 1 shows an X-ray diffraction spectrum of fabricated nanoporous copper powders.

### DETAILED DESCRIPTION

The present disclosure describes methods of preparation of nanoporous metal powder (NPMP) and mixtures of NPMP and Cu nanoparticles. The present disclosure also describes the use of NPMP and mixtures of NPMP and Cu nanoparticles in the preparation of solid and electrically conductive copper parts via Ostwald ripening and nanoscale welding at sintering temperatures below the melting temperature of bulk copper.

NPMP production methods include (i) combustion synthesis of metallic alloys, (ii) directed- (e.g., two photon lithography) or self-assembly (e.g., block-copolymers and capillary assembly of nanospheres) of sacrificial templates combined with metal deposition methods, (iii) dealloying of powder precursor alloys made by ball-milling, gas-or plasma-atomization, and (iv) ball milling of dealloyed thin-films, foils or other bulk formats. Integration of NPMP with powder metallurgy can be advantageously achieved with a combination of one or more of High-volume production (e.g., kg/hr), morphology control such as powder size distribution, superior spheroidicity, and dispersion, selected to reduce or prevent interlocking and agglomerates, and yield a flowable feedstock at scale. Combustion synthesis offers high throughput, but low surface area (e.g., 0.8-3.5 m²/g) due at least in part to high processing pressures and temperatures. Dealloying of plated hollow, ball milled and gas atomized powder alloys can yield small pore sizes, dependent at least in part on its thermodynamic limitations (e.g., adatom diffusion rate and coarsening). Due at least in part to irregular particle shapes and wide size distribution, ball milling can lead to poor flowability and particle interlocking, resulting in low powder packing factor and porosity in the final part. Also, the use of dealloyed hollow metal particles can result in low density of the part. Therefore, the use of NPMP derived from gas-atomized powders can be suitable for integrating with either powder casting methods (e.g., open-die casting and powder injection molding) or powder-based metal additive technologies (e.g., selective laser melting, metal fused filament fabrication, binder jetting, and directed energy deposition).

In powder formats, synthesis of NPMP may be affected by: (i) selection of suitable precursor alloy compositions and phases due at least in part to rapid solidification during its production (e.g., gas-atomization), (ii) incompatibility of powders with electrolytic forms of dealloying which can limit control of reaction kinetics and pore sizes, (iii) exothermic reactions leading to uncontrollable and hazardous thermal runaway due at least in part to its large surface-to-volume ratio, (iv) undesirable precipitate formation (e.g., metal hydroxides), and (v) high reactivity with atmospheric oxygen and nitrogen leading to limited air-handling capability, which can be alleviated by passivation strategies for non-noble NPMP (e.g., Cu, Ni, Al, etc.) or handling in costly inert environments.

Integration of NPMP into powder metallurgy and fabrication of nanoporous conductive metal parts can include welding while preserving porosity. Nanoporous metals are metastable at onset temperatures as low as one-tenth of its melting point and undergo a thermal coarsening process that is both time-and temperature-dependent. Another factor in metal-to-metal welding is the management and removal of the oxides for non-noble metals both before sintering when the powders are removed from dealloying solution and during its sintering cycle.

As described herein, solid and electrically conductive copper parts are produced by exploiting Ostwald ripening and nanoscale welding between NPMP and their mixtures containing Cu nanoparticles at sintering temperatures as low as 28% of melting temperature of bulk copper. The large-scale bulk synthesis (e.g., 0.1 kg/h with a single tabletop 5 L beaker) of nanoporous copper powder (PCu) powder can be achieved by (i) titrating NaOH into a suspension of copper-aluminum (CuAl) powder and water and (ii) by titrating CuAl powder into a NaOH solution. The latter approach can be used to avoid or minimize the formation of bayerite precipitates and copper oxides (e.g., Cu₂O and CuO) by maintaining high concentrations of NaOH (e.g., 3 M) during dealloying. Surface passivation of PCu powder with a copper oxide layer can be achieved by exposing it to ambient conditions. In some examples, hybrid feedstocks containing 8.8 to 34.5 vol % of 300 nm Cu nanoparticles (CuNP) and PCu powder are fabricated to increase the packing density and facilitate nanoscale welding via Ostwald ripening of nanoparticles which promotes necking of the micron-sized PCu powder. The hybrid feedstock is typically subjected to sintering in an open-die graphite mold in reducing atmosphere at a temperature range of 300-700° C. to fabricate electrically conductive parts. Parts were subjected to compression testing achieving a low mechanical strength (e.g., maximum ultimate compression strength of 17.8 MPa) with preserved porosity and ligament sizes ranging between 24-36 nm, which is attributed to the high thermal stability of PCu ligaments between 300-600° C. As described herein, NPMP and mixtures of NPMP containing Cu nanoparticles can be used in powder injection molding and additive manufacturing.

### EXAMPLES

### Materials and Methods

Spherical Copper-Aluminum (Cu₃₃Al₆₇ in atomic fractions) gas atomized powders were purchased from Valimet Inc. Corresponding particle size distribution of Cu₃₃Al₆₇ powders according to Aerodynamic particle sizer (APS) measurements performed by Valimet Inc. was as following: D₁₀-4.36 μm, D₅₀-11.76 μm, D₉₀-28.55 μm. 37 wt % sodium hydroxide (Reagent grade) was purchased from Sigma Aldrich. Anhydrous ethanol (Reagent grade) was purchased from Carolina. Automatic self-zeroing burette (10 mL) with a 1000 mL glass vessel was purchased from Eisco Labs.

### Scanning Electron Microscopy (SEM) and Electron Dispersive Spectroscopy (EDS)

SEM and EDS analysis of nanoporous copper (PCu) powder was performed using Zeiss Auriga SEM. X-ray diffraction (XRD) analysis was performed on Bruker D8. Brunauer-Emmett-Teller (BET) specific surface area and Barrett-Joyner-Halenda (BJH) average pore size were analyzed on Micromeritics Tristar II Plus equipment. The sintering of powder was performed in Ar and 95% Ar/5% H₂ mixture environments in Carbolite Gero EST1200 tube furnace. The drying of PCu powder was performed in vacuum oven (Across International. The handling of PCu powder was performed both in air and in Ar-filled glovebox.

### Differential Scanning Calorimetry (DSC) and Thermogravimetric (TGA) Analysis

DSC and TGA analysis were performed on SETARAM LABSYS evo DTA/DSC. Samples were loaded in 20-50 mg quantities into alumina crucible and analyzed against alumina particles. At first, helium gas was purged for 20 min to avoid any buoyancy effects at higher temperatures. After that, samples were heated at 5K/min until 1100° C. was reached.

### Flowability

Flowability was evaluated with Hall and Carney flowmeters indicated by ASTM B213-20 and ASTM B964-16 standard tests, respectively. In both tests, a weighted mass of 50 g of dry powders was deposited into the flowmeter funnel with blocked discharge orifice, and once discharge orifice was released, flow rate was timed as the metric of flowability. Hence, the shorter the time the more flowable the powders. Standards regulate that if powders are not flowable through the initially used Hall flowmeter funnel (diameter of discharge orifice Ø=0.10 in), then tests are to be performed with Carney flowmeter funnel (diameter of discharge orifice Ø=0.20 in). The process was repeated 3 times for each sample. The Hall and Carney flowmeter funnels were obtained from Qualtech Products Ltd.

### In-Situ Resistance

In-situ resistance measurements were configured by the use of ER316L wires as connection probes to the samples in alumina crucibles under 95% Ar/5% H₂ mixture and oxygen atmospheres. The experiments were conducted with temperatures up to 400° C., at 5° C./min with three resistance measurements taken for each sample every 50° C. step during heating cycle.

### Mechanical Testing

Mechanical testing of casted parts was performed on Instron 59944 with 1 kN of applied force.

### Example 1. Preparation of Porous PCu Powders

Production scaling of PCu by dealloying of copper-aluminum (CuAl) powder with a large particle size (e.g., 100 nm-30 μm) is hazardous due at least in part to its high surface area compared to that of thin films and other bulk formats, and the exothermic nature of the aluminum etching process that can result in an uncontrollable thermal runaway reaction. Steps included herein to suppress thermal runaway were (i) titration of either etchant or powder precursor and (ii) preheating the solution at the beginning of the experiment.

Two approaches for producing oxide-containing PCu powders—with an oxygen content greater than 10 at %—are presented herein without regards as to whether the oxide formation took place in the etching solution or during exposure of the powder to atmosphere. Also, their role in regulating the formation of precipitates is described. The two approaches for dealloying include immersing CuAl powders (e.g., precursor) into an aluminum etching NaOH (aq) solution by: (i) titrating the latter into CuAl powders suspended in deionized water until a 3M solution concentration is reached, and (ii) titrating CuAl powders in timed intervals into 3 M NaOH (aq) solution (‘2nd approach’). Subsequently, the origin of oxide formation is identified to be the exposure to atmospheric conditions and a method for its regulation is presented yielding oxide content as low as 11±1 at %.

### Procedures

PCu powder was fabricated using two different approaches:
(1) by titrating 260 mL of concentrated NaOH solution at a titration rate of 4 mL/min using 10 mL self-zeroing burette into deionized water (2240 mL) with a dispersed CuAl precursor powder (50 g), and
(2) by titrating CuAl precursor powder (50 g) at a rate of 1 g every 30 s into 3M NaOH solution (2500 mL).

Procedure 1: A 5000 mL glass beaker containing 2240 mL deionized water with a dispersed CuAl powder was placed on a hotplate with a setpoint temperature of 250 C and heated to 50° C. within 30 min at a constant stirring rate of 300 RPM. Immediately after reaching the target temperature, the hotplate was turned off and NaOH solution was titrated using a burette at a rate of 8 mL/min resulting in 32 min 30 s of total dealloying time. The hydrogen bubbles were generated as a result of aluminum etching and were evidenced throughout the whole dealloying process which is an indicator of slow etching reaction rate.

Procedure 2: A 5000 mL glass beaker containing 2500 mL of freshly prepared 3M NaOH solution was placed on a hotplate. Due at least in part to the exothermic reaction of NaOH dissolution with water, the prepared solution naturally heated to 52±1° C. The beaker with solution was left on a hotplate to cool down to 45° C. with a stirring speed of 300 RPM and immediately after that the temperature on a hotplate was set to 250° C. and solution was heated to 50° C. After reaching the desired temperature, CuAl powder was titrated at a rate of 1 g every 30 s with a total titration time of 24 min 30 s. After all powder was used, PCu was kept 5 additional minutes in dealloying bath to complete Al etching. The hydrogen bubbles were rapidly generated and were observed in first 5 min of dealloying, indicating that the rate of the aluminum etching reaction is higher than using first titration approach.

The temperature profiles were recorded for PCu fabrication using both titration approaches from the start of titration and until produced powder was ready for washing. PCu powder was washed with 1L of deionized water and 200 mL of anhydrous ethanol. Powders were transferred to the vacuum oven in one beaker to dry at 90 C for 4 h. The drying procedure was changed in the case of the oxide incorporation study since it was found that drying of powder in large amounts with low surface-to-volume ratio can lead to exothermic runaway with rapid heat generation.

PCu powder drying for oxide incorporation

The nature of oxide incorporation in PCu powder fabricated using the 2nd approach was investigated as follows. In the first experiment, a freshly prepared PCu powder with a mass total of 25 g (PCu-25) was dried in vacuum oven at 90° C. for 8 h and exposed to air in the same beaker with a high-aspect ratio (e.g., 130 and 85 mm in height and width respectively) and the oxidation temperature and Tₘₐₓ were recorded. Then, the aspect ratio of the beaker was decreased (e.g., 18 and 145 mm in height and width respectively) and the same quantity of PCu powder (e.g., 25 g) was dried and exposed to air. In the second experiment, the low-aspect ratio beaker was used as a vessel for PCu powder drying and the quantity of the powder was varied from 5 to 100 g per beaker (e.g., when the thickness of powder layer is from 0.3 to 6 mm). The temperatures were recorded by IR thermocouple.

Powders obtained using the 1st approach exhibit a nanoporous core with a morphology characteristic of dealloying. After vacuum drying and exposure to atmosphere, the XRD data, revealed that the core is composed of cuprite (Cu₂O). Cuprite can form (i) during dealloying due at least in part to partial oxidation in solution of generated copper adatoms and (ii) after exposure to atmosphere by oxidation of copper. EDS data shows the powder after exposure to air becomes heavily oxidized with 60.2 at % of oxygen, 29.1 at % of aluminum and 10.1 at % of copper. During dealloying of CuAl alloy in both approaches, aluminum is selectively etched with formation of dissolvable sodium aluminate (NaAlO₂) and the reaction is described as follows:

$$2 Al + 2 NaOH + 2 {H}_{2} O = 2 {NaAlO}_{2} + 3 {H}_{2} \qquad ( 1 )$$

However, in the 1st approach, at low concentrations of sodium hydroxide during the onset of titration, aluminum preferably reacts to form aluminum hydroxide Al(OH)₃ via its hydrolysis:

$$2 Al + 6 {H}_{2} O = 2 {Al ( OH )}_{3} + 3 {H}_{2} \qquad ( 2 )$$

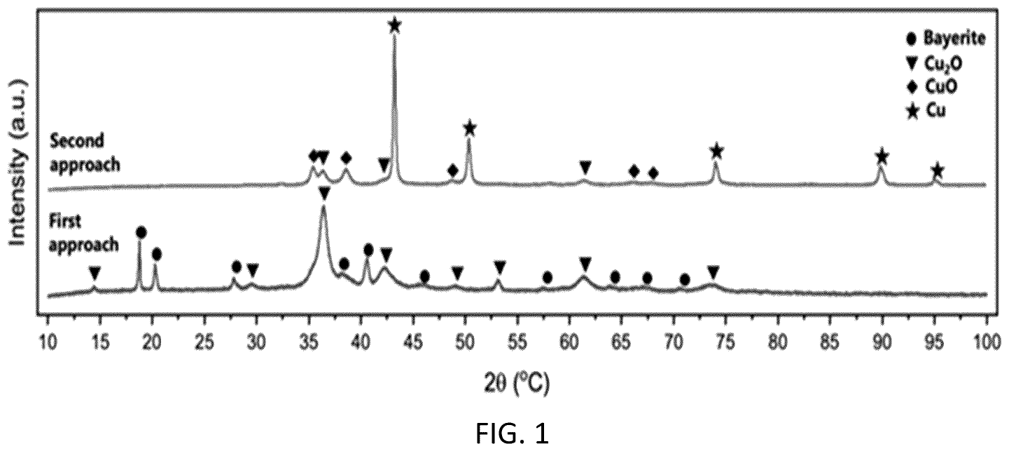

Precipitates were analyzed by EDS and XRD, which revealed their oxygen and aluminum rich compositions (e.g., 29.1 at %), and identified the crystal structure of Al(OH)₃ to be a single-phase bayerite with the first diffraction peak at 18.739° as shown in FIG. 1. No crystalline pure aluminum or its oxides were observed by XRD data suggesting most of it was converted to Al(OH)₃ in solution. It was found that bayerite is usually formed when the molarity of Al³⁺ is 0.1-1 mol/L and NaOH concentration is 0-0.7 M at a solution temperature between 60 and 80° C. Similarly, the concentrations of NaOH solution and Al³⁺ increase from 0 to 3 M and from 0 to 0.35 mol/L, respectively, while the solution temperature was increased from 50 to 72° C. During the etching in the 1st approach, the color of the solution became dark and opaque which is characteristic of a solution saturated with aluminum hydroxide.

The 1st approach allowed the powders to experience similar etching rate and temperature oscillations while yielding bayerite precipitates. The 2nd approach titrated powder into a highly concentrated NaOH solution which may introduce fluctuations in the concentrations of NaOH, pH, Al³⁺ at each iteration of titration, which could lead to non-uniformities in a given batch. However, the chance of forming aluminum hydroxide (equation 2) in the 2nd approach is minimized due at least in part to the high NaOH concentration. Instead, aluminum (e.g., 0.7mmol/L total at each titration step) reacted with sodium hydroxide (equation 1) resulting in rapid formation of sodium aluminate products which was evidenced by a white appearance during dealloying followed by its subsequent dissolution into the electrolyte leading to a clear and translucent solution upon the completion of dealloying. The white appearance of the etching solution was not observed during synthesis of powders using the 1st approach. According to stoichiometric calculations based on (1), the amount of NaOH used was 8.5 times greater than what was stoichiometrically expected to etch all of the aluminum in the precursor powders in both dealloying approaches. Thus, powders obtained using the 2nd approach exhibited nanoporous structure free of precipitates. XRD data in FIG. 1, obtained after vacuum drying and exposing to the atmosphere, revealed that powders showed prominent crystalline Cu peaks at 43.4, 50.5, 74.2 degrees 2Θ, which were absent for powders fabricated following the 1st approach. Moreover, according to EDS data the amount of copper in PCu oxide powder was 57.5 at % which was 47.4 at % higher than in bayerite-covered PCu oxide powder from the 1st approach.

### Regulation of Oxygen Incorporation

Although SEM and XRD analysis of oxide-containing PCu powders fabricated following the 2nd approach did not reveal any presence of bayerite, the powder contained a substantial amount of oxygen (e.g., 38.7 at %) in the form of Cu₂O and CuO after its exposure to atmosphere. Oxides have been known to form both in solution during dealloying and by post-oxidation in atmospheric conditions. Therefore, to make a distinction of whether oxides were formed during dealloying process or after exposure to air, a detailed analysis of the kinetics of PCu oxidation was done by examining the contributions of the drying process and exposure of powder to atmosphere to its oxygen content.

The oxidation of PCu powder after drying and venting into atmospheric conditions at room temperature (e.g., 20-24° C.) was accompanied by rapid heating of the sample whose temperature profile and maximum temperature (Tₘₐₓ) were recorded with an infrared thermometer gun. This increase in temperature can be either moderate (e.g., Tₘₐₓ<55° C.) when heat can dissipate at a high rate, or extreme (e.g., Tₘₐₓ>325° C.) when an uncontrollable high- temperature exothermic runaway (HT-ER) takes place. In the latter scenario, temperatures are higher than the porous structure stability threshold (PSST) and PCu powder began to thermally coarsen which was confirmed with DSC analysis (e.g., the onset of thermal coarsening is 95-100° C. for PCu). Without being bound by theory, this temperature rise may regulate the rate and total amount of oxygen incorporation since the oxygen diffusion constant follows an Arrhenius dependence with temperature. To test this, the rate of heat dissipation was varied by increasing the surface area to volume ratio of the powder in the beaker either (i) by increasing its aspect ratio at a constant quantity of the powder or (ii) by decreasing the thickness of the powder layer in a beaker by reducing its quantity per beaker. In the first approach, its aspect ratio was varied from 1.5 to 0.12 for a fixed amount of 25 g of PC (e.g., PCu-25), and it was possible to reduce the final oxygen content from 38.7 to 19.8 at % and Tₘₐₓ from 350 to 55° C. Second, by decreasing the powder quantity in a given beaker and, consequently, its layer thickness from 6 mm (e.g., PCu-100) to 0.3 mm (e.g., PCu-5), it was possible to reduce the oxygen level from 44.8±1.0 to 11.1±2.1 at % and Tₘₐₓ from 399 to 27° C. respectively. The core-shell structure was preserved for PCu powder with oxygen content below 40 at % (e.g., for PCu-5, PCu-20, PCu-25 and PCu-35). The PCu-50 and PCu-100 were fully oxidized to CuO without the presence of crystalline Cu according to XRD analysis.

The presence of the HT-ER in addition to regulating oxygen incorporation also influences the type of oxide (Cu₂O or CuO) formed as evidenced (i) by XRD data and (ii) by its light brown and gray coloration. Copper oxidation into Cu₂O is spontaneous at room temperature and its oxidation into CuO initiates at temperatures above 250° C. at atmospheric pressures. Thus, CuO is only present in HT-ER samples whose Tₘₐₓ were 325-399° C. Besides oxygen content, temperature increases can induce thermal coarsening which was interrogated as a function of the powder layer thickness by BET and BJH methods. Although PCu powders that did not experience HT-ER had Tₘₐₓ ranging from 29 to 58° C. which is below PSST, BJH and BET data revealed that the average pore size increased and specific surface area decreased with increasing mass and Tₘₐₓ, respectively, which is indicative of thermal coarsening. For samples that experienced HT-ER, surface area continued to decay with increasing mass and Tₘₐₓ. However, a sharp drop in their pore size was observed which is consistent with SEM image analysis.

### Example 2. Nanoscale Welding of Nanoporous Copper Powders

The goal of establishing welding across nanoporous copper powders to form electrically conductive parts offered investigation of (i) thermal reduction of oxides during sintering in 95% Ar/5% H₂ mixture, (ii) welding of copper across powder-to-powder interfaces, and (iii) their electrical resistance as a function of sintering temperature. Unlike well-known sintering approaches that take place at 70-92% of the melting point of a material to weld powders (e.g., 750-1000° C. for copper), as presented herein, individual ligaments can be welded across their powder-to-powder interface by surface diffusion and driven by the metastability of the nanoporous copper and the mismatch in surface energy upon contact between ligaments at temperatures as low as 28-46% of the melting temperature of Cu (e.g., 300-500° C.). Such low temperatures not only serve to establish welding and the formation of a rigid and conductive solid, but also to preserve the nanoscale porosity and high-surface area of the nanoporous copper which is not stable at high temperatures (e.g., 600-700° C.).

Oxide decomposition was examined as a step towards nanoscale metal welding. The resistance across a powder pack during heating from room temperature to 400° C. in a reducing atmosphere (Ar mixed with 5 vol % of H₂) was monitored in-situ. At room temperature, powders possessed a high resistance due at least in part to the presence of the oxide. An 8-order of magnitude drop in resistance occurred for both PCu-5 and PCu-100 at the onset temperature of ˜200° C. which indicated that Cu₂O and CuO were thermally reduced in reducing atmospheres. Oxide reduction had an onset at ˜200° C. for both samples and ended at ˜270° C. and ˜350° C. for PCu-5 and PCu-100, respectively. After that, powders were allowed to sinter in an oxide-free state. During the cooling cycle, oxygen was introduced at 300° C. to intentionally passivate the welded powders with an oxide. If ligaments weld during heating, that step will passivate them, ligaments will be ‘bridged’ between powders and electrical contact will be maintained which was indeed the case for the PCu-5 sample. However, the PCu-100 sample exhibited a 7-order of magnitude gain in its resistance during the cooling cycle which indicated the breakage of electrical contact between particles. Also, the PCu-5 sample appeared solid at the end of the cooling cycle while the PCu-100 sample was still in a powder consistency and could not hold its shape. The lack of ligament-like morphology in the PCu-100 sample was the primary cause for its poor sinterability and limited nanoscale welding.

### Example 3. Powder Casting of Porous Copper Parts

In the first sintering experiment, PCu-5 powder was sintered in 95% Ar/5% H₂ mixture atmosphere at 700° C. in a graphite crucible for 24 h. In the second experiment, PCu-5 powder was homogenized with 300 nm CuNPs (8.8-34.5 vol %) using ball mixing machine operated without milling balls and at low attrition speeds effectively acting as a planetary mixer. The sintering was performed at temperatures from 300 to 700° C. After sintering, casted parts were removed from inert atmosphere to air.

Since the approach to synthesize PCu powders as disclosed herein allows them to preserve their spherical shape after dealloying and, albeit shrinkage of its diameter (e.g., 11% by volume) their flowability which was measured by the Carney method, which yielded a flow rate of 32.9 s per 50 g for PCu while its solid CuAl precursor failed the same test after 3 taps. In a first attempt, pure PCu-5 powder was sintered in an open-die mold at high-temperatures (600-700° C.) in reducing atmosphere (e.g., 95% Ar/5% H₂ mixture) and resulted in a conductive solid with poor mechanical integrity and brittleness evidenced by its fracture upon the soft touch of hand manipulation and loose aggregates (e.g., easily crumbled). The low electrical resistance and rigidity of the part established after sintering and exposure to atmosphere was attributed to nanoscale welding of ligaments in PCu bridging the metal across particle-to-particle interfaces since any contact or welding between Cu₂O would not yield a conductive solid. Focused ion beam (FIB) cross-sections and SEM images of the contact interface between sintered PCu powders confirm this and no oxygen was observed inside the welded interface according to EDS measurements. The brittle behavior was attributed to the low-density of contact points between powders which arose from the size difference between the ligament size and the powder size which is greater than an order of magnitude. Thermal coarsening of the nanoporous structure increased the ligament size relative to the powder size and can promote necking formation. In a second attempt, this was addressed by using a hybrid feedstock in which CuNPs were added in small fractions (e.g., 8.8-34.5 vol % of CuNPs) to promote welding between themselves and P—Cu powders and increased the neck size between PCu particles. Loading of CuNPs by volume was calculated considering skeletal density and shrinkage of PCu powder after dealloying and neglected density changes due at least in part to oxidation.

First, casted blocks with 8.8 vol % of CuNPs using this hybrid feedstock were sintered at 300-700° C. and did not crumble apart or crack upon soft touch with shape retention after demolding which is attributed to additional nanoscale welding between PCu and CuNPs. Due at least in part to Ostwald ripening, CuNP agglomerates coalesced between themselves, and recrystallized at 400° C. and above, leading to crystal growth and faceting. At the same time, CuNPs welded with ligaments on the surface of PCu powder. The crystallite size of sintered CuNP agglomerates (˜1-5 μm in size) were much larger than ligaments in PCu which remain small (˜24-36 nm) even after heat treatment at 600° C., suggesting the latter is more stable than the former. This is a phenomenon in sintering of hybrid feedstocks that enables the preservation of the high-surface area of PCu while improving the neck size between PCu powders. An additional observation was that the recrystallization front of CuNP conformed to the surface of PCu powders which closed its surface pores in PCu into a thermodynamically stable configuration (e.g., closed round pore) at their interface.

While parts were solid and oxygen-free after sintering inside the argon (Ar) glovebox, heating was observed upon their removal to air in ambient conditions. Similar to drying of the PCu feedstock at different powder thicknesses, parts heated to its Tₘₐₓ and formed copper oxides on its surface. Parts sintered at 300 and 400° C. exhibited Tₘₐₓ>365° C. and lost structural integrity (e.g., cracked in half) with its outer shell heavily oxidized to CuO evidenced by the change in color on its outer layer. Therefore, these parts can be used in inert environments or in packaged devices. Parts sintered at 500, 600 and 700° C. did not overheat (Tₘₐₓ<102° C.) upon their exposure to air in comparison to the parts sintered at 300 and 400° C. which is attributed to the thermal coarsening of its ligaments and reduction in surface area which minimizes heat generation during its exposure to the atmosphere. Small segments (e.g., <1 mm) were extracted from 300 and 400° C. samples to eliminate heat generation in the sample and to analyze ligament diameter and extract the slope of ligament coarsening (nEa). The ligament morphology disappeared on the PCu surface at 700° C. DSC and TGA data of PCu-5 powder showed the onset of an endothermic peak at 650° C. without any loss of its mass suggesting it is melting. The thermal stability of PCu up to 600° C. observed in casted parts can be beneficial for attaining the lowest possible shrinkage of the final product (since thermal coarsening leads to its shrinkage and negative coefficient of thermal expansion). It was found that sintered Cu blocks sintered at 600° C. can result in 9.2, 20.7 and 29.7 vol % shrinkage at 8.8, 17.6 and 34.5 vol % of CuNPs loading, respectively, which supports that CuNP is the main contributor to shrinkage at high loadings.

To quantify the mechanical performance of sintered Cu blocks, compression tests were performed on the samples sintered from 500 to 700° C. which excludes the ones not stable in air (e.g., T=300-400° C.). Samples sintered at 500° C. with increasing CuNP loading exhibited a decreasing trend in the ultimate compression strength (UCS). At high CuNPs loadings, rather than filling the gaps between the necks of welded PCu powders, sintered CuNP can fill the region between PCu powders and eliminate weld regions between them. By maintaining the CuNPs loading constant (e.g., 8.8 vol %), an increasing trend in the UCS with increasing temperature was observed which highlights its trade-off with the final pore size and surface area since the latter was also temperature dependent. The UCS values yielded 3.6 MPa (e.g., for pure CuNPs sintered at 500° C.) and 17.8 MPa (e.g., for PCu with 8.8 vol % of CuNPs sintered at 700° C.) and the latter was still one order of magnitude less than bulk copper. As a reference, the sintered block made of pure CuNPs exhibited even lower UCS of 3.6 MPa which, albeit measurable, sintered CuNPs appears to be crumbly. All sintered parts independent of both sintering temperature and CuNPs content yielded at 2.4±0.3 MPa, which is indicative of the presence of defects in the sintered Cu parts that fracture at stress concentrations around the neck zones whose cross-sectional area are still too small compared to the powder size. A summary of the mechanical testing data is presented below in Table 1.

TABLE 1
Data and observations of PCu blocks sintered at temperatures from 300 to 700° C.

| | CuNPs | | Structural | Structural | Estimated | Measured | Estimated |
|---|---|---|---|---|---|---|---|
| Sintering | content | Tₘₐₓ | integrity | integrity | YCS | aUCS | UCS |
| Temp. ° C. | (vol %) | ° C. | (in Ar) | (in air) | (MPa) | (MPa) | (MPa) |
| 300 | 8.8 | 380 | Solid* | Crumbly* | Not tested | Not tested | Not tested |
| 400 | 8.8 | 365 | Solid | Crumbly | Not tested | Not tested | Not tested |
| 500 | 34.5 | 102 | Solid | Solid | 2.1 | 1.6 | 5.8 |
| 500 | 17.6 | 42 | Solid | Solid | 2.1 | 1.7 | 6.1 |
| 500 | 8.8 | 54 | Solid | Solid | 2.9 | 2.2 | 8.8 |
| 500 | 100 | 24 | Crumbly | Crumbly | 0.5 | 1.6 | 3.6 |
| 600 | 8.8 | 56 | Solid | Solid | 2.9 | 2.3 | 11.5 |
| 700 | 8.8 | 27 | Solid | Solid | 2.4 | 3.6 | 17.8 |

*‘crumbly’ refers to samples that fractured upon hand manipulation; ‘solid’ refers to samples that were submitted for mechanical compression testing

Although this disclosure contains many specific embodiment details, these should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

What is claimed is:

1. A method of preparing nanoporous copper powder, the method comprising:
contacting a precursor powder comprising copper and aluminum with NaOH to dealloy the powder, thereby yielding nanoporous copper powder;
washing the nanoporous copper powder;
drying the nanoporous copper powder; and
passivating the nanoporous copper powder to form a copper oxide layer on the nanoporous copper powder.

2. The method of claim 1, wherein contacting the precursor powder with the NaOH comprises adding the NaOH to an aqueous mixture comprising the powder.

3. The method of claim 1, wherein contacting the precursor powder with NaOH comprises adding the precursor powder to an aqueous solution of NaOH.

4. The method of claim 1, wherein the precursor powder comprises spherical copper-aluminum particles.

5. The method of claim 1, wherein the nanoporous copper powder is substantially free of copper oxides before passivating the nanoporous copper powder.

6. The method of claim 1, wherein passivating the nanoporous copper powder comprises maintaining the nanoporous copper powder at a temperature below about 200° C.

7. The method of claim 6, wherein, after passivating, the nanoporous copper powder is free of CuO.

8. The method of claim 1, further comprising combining the nanoporous copper powder with copper nanoparticles to yield a powder mixture.

9. The method of claim 8, wherein the powder mixture comprises up to 40 vol % of the copper nanoparticles.

10. The method of claim 1, wherein a particle size of the precursor powder is in a range of about 10 nm to about 30 μm.

11. A method of welding nanoporous copper powder, the method comprising:
heating a feedstock comprising the nanoporous copper powder in a reducing atmosphere to reduce the nanoporous copper powder; and
heating the feedstock at a temperature in a range of 100-500° C. to yield a nanoporous welded solid.

12. The method of claim 11, wherein the reducing atmosphere comprises H₂.

13. The method of claim 11, wherein the feedstock further comprises copper nanoparticles.

14. The method of claim 13, wherein the feedstock comprises up to 40 vol % of the copper nanoparticles.

15. The method of claim 11, further comprising casting the feedstock in a mold before heating the feedstock.

16. The method of claim 15, further comprising removing the nanoporous welded solid from the mold.
